(19) United States
(12) Patent Application Publication
(10) Pub. No.: US 2020/0387843 A1
(43) Pub. Date: Dec. 10, 2020

(54) RISK MANAGEMENT OF PROCESSES UTILIZING PERSONAL DATA

(71) Applicant: TrustArc Inc, San Francisco, CA (US)

(72) Inventors: Hilary M. Wandall, Center Valley, PA (US); Joseph Jacob Green, San Francisco, CA (US); Neng Gu, San Jose, CA (US); Maciej Switalski, Peachland (CA)

(21) Appl. No.: 16/894,773

(22) Filed: Jun. 6, 2020

Related U.S. Application Data
(60) Provisional application No. 62/936,607, filed on Nov. 18, 2019.
(60) Provisional application No. 62/916,205, filed on Oct. 16, 2019.
(60) Provisional application No. 62/858,979, filed on Jun. 8, 2019.
(60) Provisional application No. 62/858,980, filed on Jun. 8, 2019.

(51) Int. Cl. G06Q 10/06; G06Q 50/26; G06N 20/00; G06N 5/04

(52) U.S. Cl. CPC G06Q 10/0635; G06Q 50/265; G06N 5/04; G06N 20/00; G06Q 10/06316

(57) ABSTRACT

A method, system and/or computer usable program product for performing a risk assessment, to a coded standard, of data-related risks within a data process including modeling the data process including identifying a purpose of the data process, identifying nodes representing data objects interconnected with edges representing data flows; and applying a set of rules associated with the coded standard against the modeled data process to provide a risk assessment to the coded standard of a degree of data-related risks generated by the data process.

### PRIORITY CLAIM

This application claims priority to U.S. Provisional Application No. 62/936,607, filed Nov. 18, 2019, entitled “RISK MANAGEMENT OF PROCESSES UTILIZING PERSONAL DATA”, to U.S. Provisional Application No. 62/916,205, filed Oct. 16, 2019, entitled “RISK ASSESSMENT ENGINE”, to U.S. Provisional Application No. 62/858,979, filed Jun. 8, 2019, entitled “DYNAMICALLY ADAPTABLE RULES AND COMMUNICATION SYSTEM TO MANAGE PROCESS CONTROL-BASED USE CASES”, and to U.S. Provisional Application No. 62/858,980, filed Jun. 8, 2019, entitled “DYNAMICALLY ADAPTABLE RULES AND COMMUNICATION SYSTEM FOR MANAGING PROCESS CONTROLS”, the disclosures of which are incorporated in their entirety herein by reference.

### BACKGROUND

### Technical Field

The present invention relates generally to personal data risk management, and more specifically to a computer-implemented method for managing the risks of processes utilizing sensitive data, including sensitive personal data protected by privacy laws.

### Description of Related Art

With the advent of the internet and mass communications of data worldwide, a host of data management issues have arisen. Many entities are gaining and sharing access to an increasingly large variety of data types, including personal data, much of which may be sensitive. In addition, this is occurring among a proliferation of data privacy, security policies, export controls, etc. For example, various governments, standard bodies and other entities have instituted a large variety of laws, regulations or rules addressing and enforcing certain data management policies (e.g., the European Union (EU) General Data Protection Regulation (GDPR) or the South African Protection of Personal Information Act (POPIA or POPI Act). As a result, it is becoming substantially more difficult to manage the storage, use and sharing of certain data and data types while complying with a multitude of laws, regulations and rules.

Whether certain laws, regulations or rules apply to an entity's data process controls depends on a variety of conditions including the type of entity, where the entity and its workers are located, the size of the entity, the type of data accessed or shared, the location of where the data was accessed or shared, the sensitivity of the data, etc. In addition, determining compliance and maturity of the entity's data process controls with applicable laws, regulations or rules is a complex and formidable task.

An example of mapping multiple governance, risk and compliance (GRC) mandates against each other in order to identify “common controls” is provided by the United Compliance Framework (UCF). UCF maintains a database of mandate “authority documents”, mandate citations, common controls and a defined terms dictionary. The UCF allows a user to input mandates of interest and to map the mandates on a one to one, one to many and many to many basis in order to produce a hierarchical list of common controls among the selected mandates. These common controls are linked to roles, assets, records, activities, events and audit questions. This list and related reports help UCF users identify overlaps among mandates, identify and remedy gaps in the user organization's GRC program and support a compliance audit program.

### SUMMARY

The illustrative embodiments of the present invention provide a method, system, and/or computer-usable program product for performing a risk assessment, to a coded standard, of data-related risks within a data process including modeling the data process including identifying a purpose of the data process, identifying nodes representing data objects interconnected with edges representing data flows; and applying a set of rules associated with the coded standard against the modeled data process to provide a risk assessment to the coded standard of a degree of data-related risks generated by the data process.

### BRIEF DESCRIPTION OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 provides a block diagram of an illustrative data processing system in which various embodiments of the present disclosure may be implemented;

FIG. 2 provides a block diagram of an illustrative network of data processing systems in which various embodiments of the present disclosure may be implemented;

FIGS. 3A-3E provide block diagrams of dynamically adaptable risk assessment and communication system modules, in which various embodiments of the present disclosure may be implemented;

FIGS. 4A-4E provide flow diagrams of the operation of dynamically adaptable risk assessment and communication system modules, in which various embodiments of the present disclosure may be implemented;

FIGS. 5A-5B provide heat maps illustrating the results of risk assessments in which various embodiments of the present disclosure may be implemented;

FIG. 6 provides a GUI (graphical user interface) for generating a data process model in which various embodiments of the present disclosure may be implemented;

FIG. 7 provides a flow diagram illustrating how a data process model is generated in which various embodiments of the present disclosure may be implemented; and

FIG. 8 provides a block diagram of a set of records 800 for a data process map in which various embodiments of the present disclosure may be implemented.

### DETAILED DESCRIPTION

Processes and devices may be implemented and utilized for a risk assessment of processes involving personal data, including sensitive data. These processes and apparatuses may be implemented and utilized as will be explained with reference to the various embodiments below.

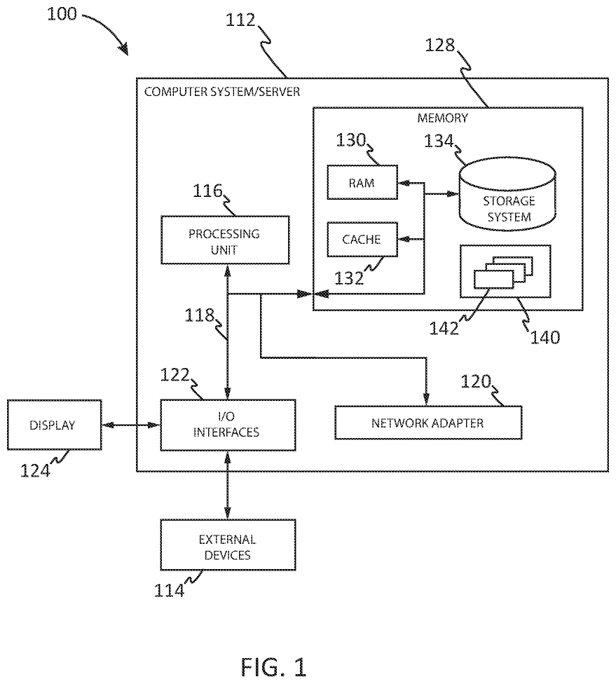

FIG. 1 provides a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as a risk assessment of processes involving personal data, including sensitive data.

In data processing system 100 there is a computer system/server 112, which is operational with numerous other general-purpose or special-purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system usable media. Such media may be any available media that is accessible by computer system/server 112, and it includes both volatile and non-volatile media, removable and non-removable media.

System memory 128 can include non-transitory computer system readable media in the form of volatile memory, such as random-access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for a risk assessment of processes involving personal data, including sensitive data.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

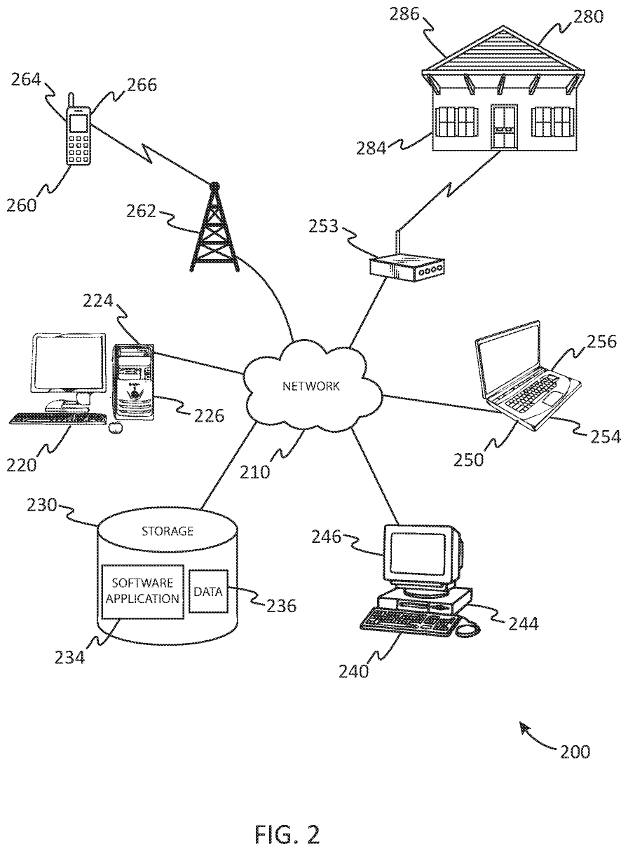

FIG. 2 provides a block diagram of an illustrative network of data processing systems in which various embodiments of the present disclosure may be implemented. Data processing environment 200 is a network of data processing systems such as described above with reference to FIG. 1. Software applications such as for a risk assessment of processes involving personal data, including sensitive data may be processed on any computer or other type of data processing system in data processing environment 200. Data processing environment 200 includes network 210. Network 210 is the medium used to provide simplex, half-duplex and/or full-duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home or business) are coupled to network 210 including wirelessly such as through a network router 253. A mobile device 260 such as a mobile phone may be coupled to network 210 through a cell tower 262. Data processing systems, such as server 220, client 240, laptop 250, mobile device 260 and facility 280 contain data and have software applications including software tools processing thereon. Other types of data processing systems such as personal digital assistants (PDAs), smartphones, tablets and netbooks may be coupled to network 210.

Server 220 may include software application 224 and data 226 for a risk assessment of processes involving personal data, including sensitive data or other software applications and data in accordance with embodiments described herein. Storage 230 may contain software application 234 and a content source such as data 236 for a risk assessment of processes involving personal data, including sensitive data. Other software and content may be stored on storage 230 for sharing among various computer or other data processing devices. Client 240 may include software application 244 and data 246. Laptop 250 and mobile device 260 may also include software applications 254 and 264 and data 256 and 266. Facility 280 may include software applications 284 and data 286 on local data processing equipment. Other types of data processing systems coupled to network 210 may also include software applications. Software applications could include a web browser, email, or other software application for a risk assessment of processes involving sensitive data, including personal data.

Server 220, storage unit 230, client 240, laptop 250, mobile device 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile device 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client-server environment in which the embodiments may be implemented. A client-server environment enables software applications and data to be distributed across a network such that an application functions by using the interactivity between a client data processing system and a server data processing system. Data processing environment 200 may also employ a service-oriented architecture where interoperable software components distributed across a network may be packaged together as coherent business applications.

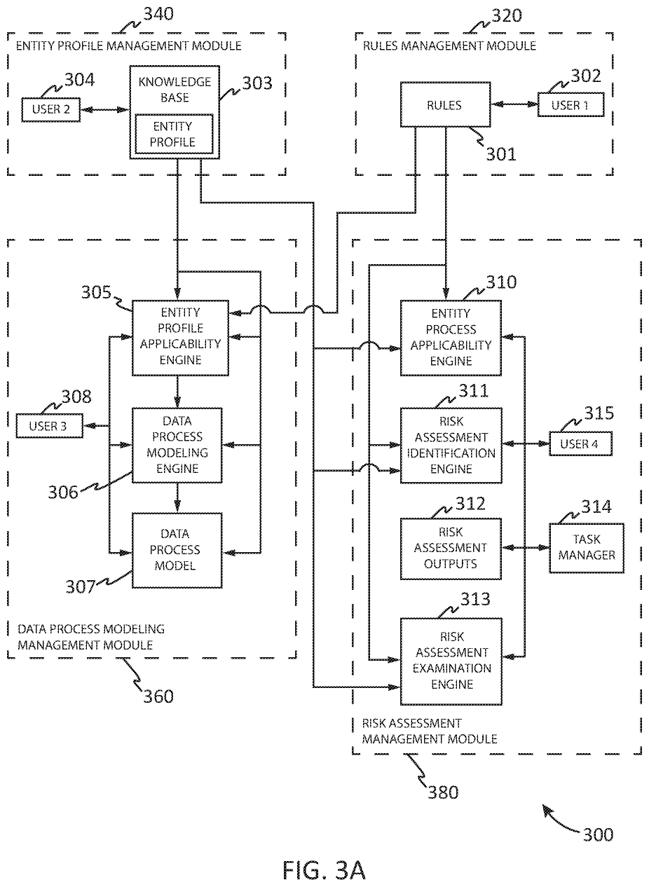

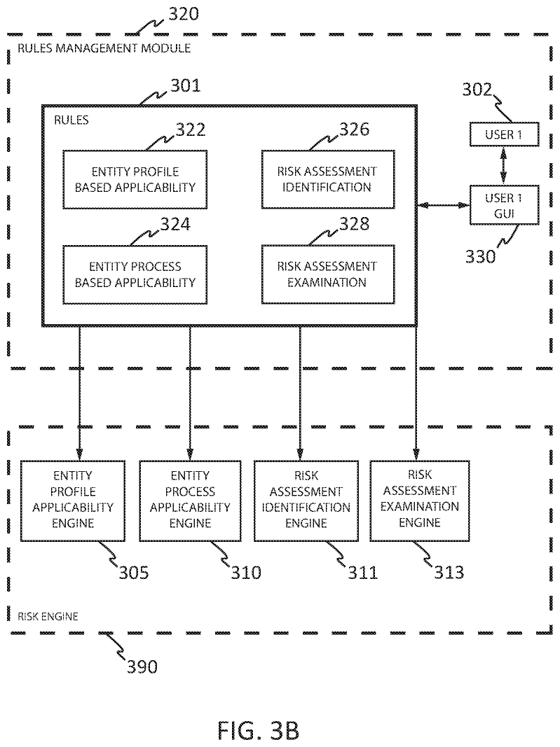

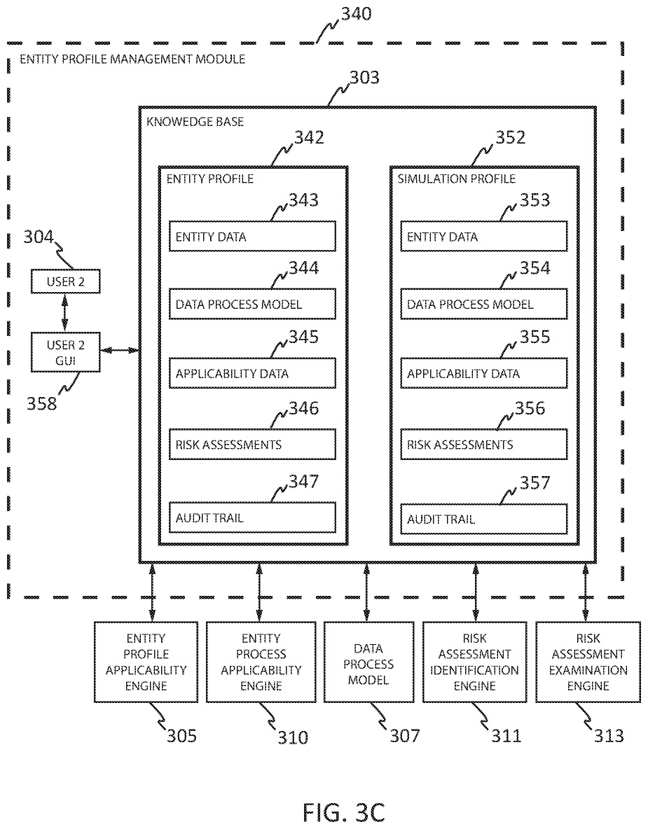

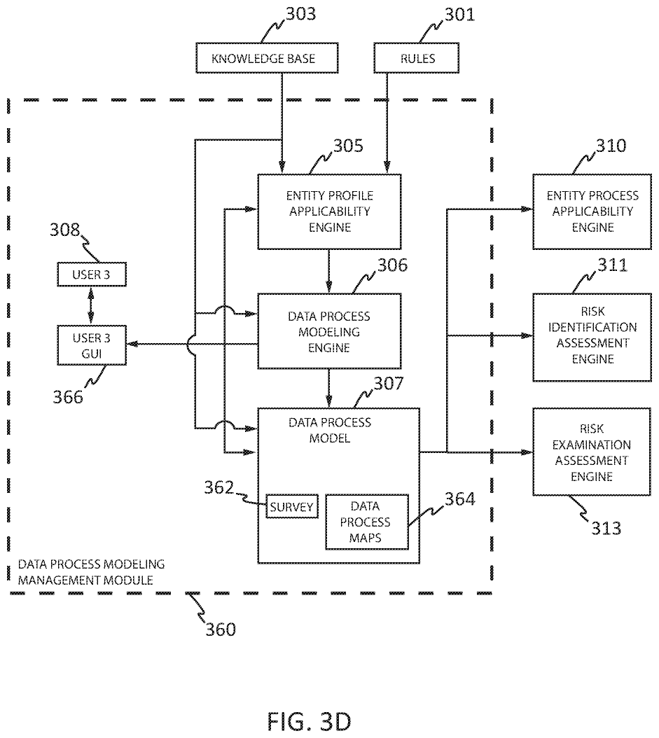

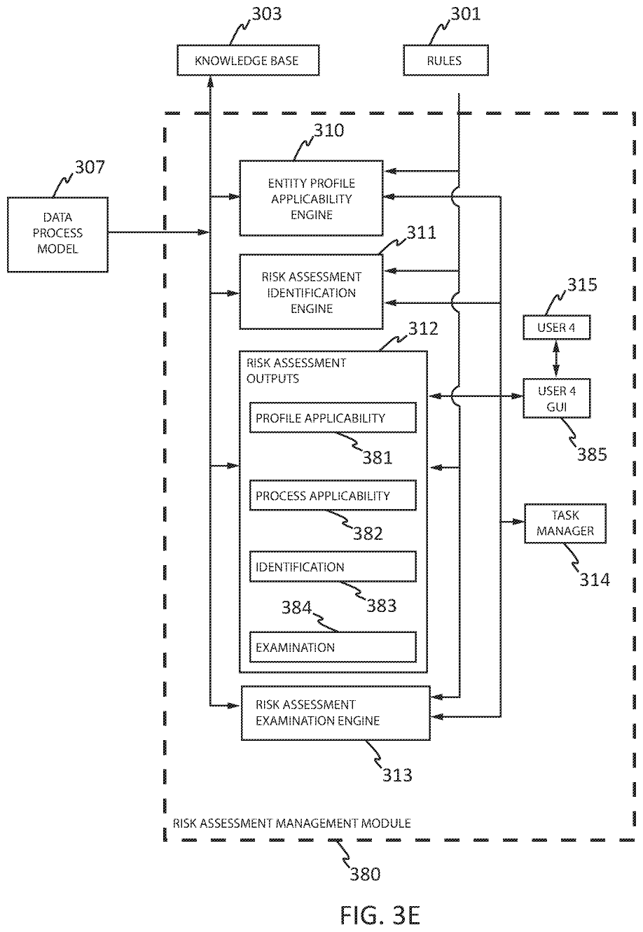

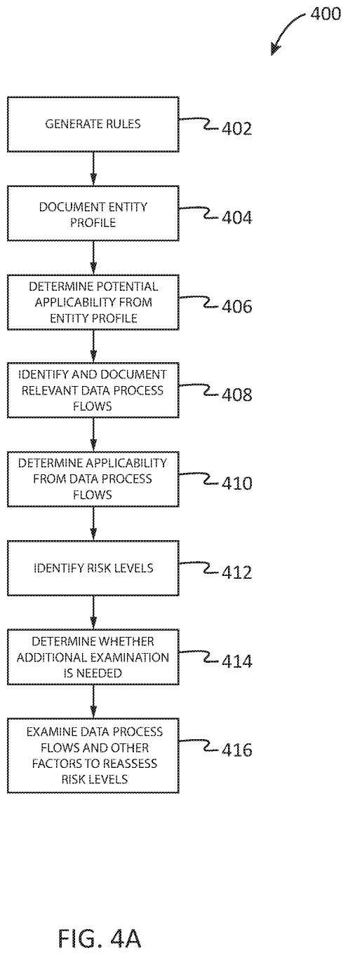

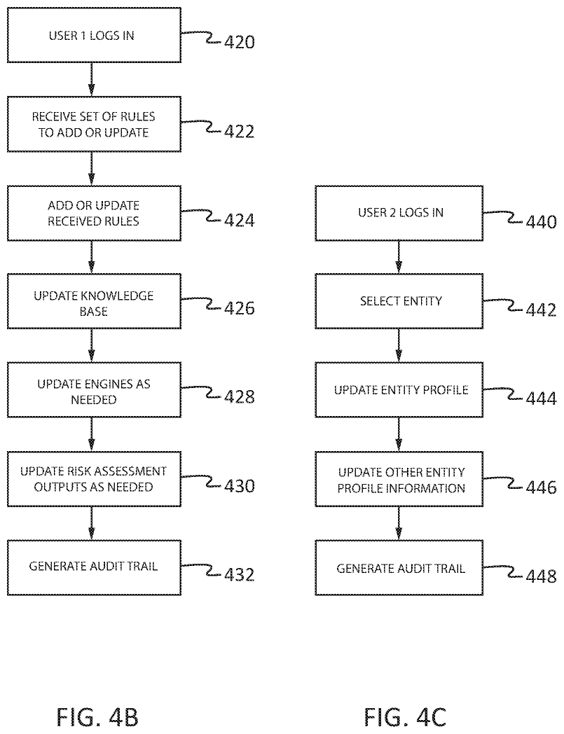

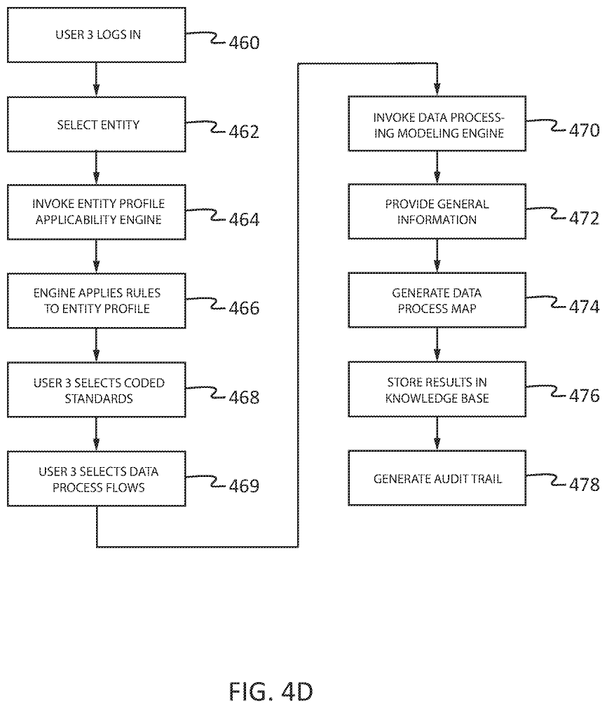

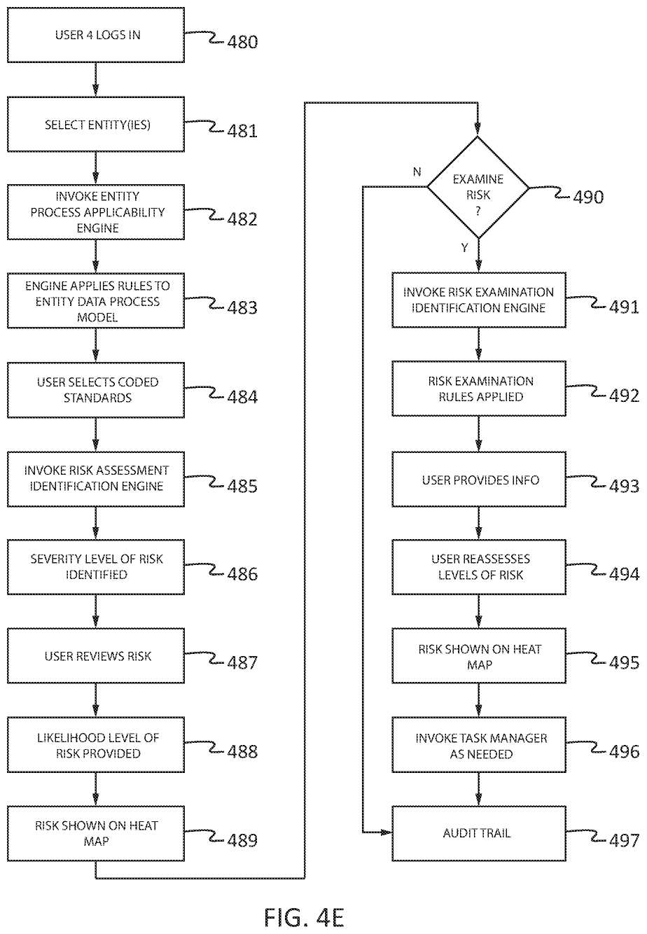

FIGS. 3A-3E provide block diagrams of dynamically adaptable risk assessment and communication system modules, in which various embodiments of the present disclosure may be implemented. FIG. 3A provides a high-level block diagram of the dynamically adaptable risk assessment and communication system 300 including multiple interacting modules 320, 340, 360 and 380 in which various embodiments of the present disclosure may be implemented. FIGS. 3B-3E provide more detailed block diagrams of each of the interacting modules 320, 340, 360 and 380 of the dynamically adaptable risk assessment and communication system 300 described with reference to FIG. 3A. In addition, corresponding flow diagrams for the overall system and for each of the multiple interacting modules are described below with reference to FIGS. 4A-4E. This dynamically adaptable risk assessment and communication system 300 includes interconnected rules engines and databases such as described herein. This system assists in determining whether certain laws, regulations, standards and other rules may be applicable to a given entity and that entity's organization and processes, providing an assessment of the risks involved in storing, using and sharing certain data and data types, and communication of that applicability determination and risk assessment. This communication facilitates collaboration among multiple users in a structured but adaptable way, to create a more efficient, computer-enabled means of assessing the applicability and risks of data processes involving personal data including a lifecycle (e.g., acquisition, storage, use, sharing and removal) of certain data and data types. In the present embodiment, personal data is referring to any data that may warrant protection, such as for privacy and/or security purposes, and is not confined to the definitions of “personal data” or “personal information” set forth in a particular law.

Alternative embodiments may be utilized to assess the applicability and risks of data processes for other data that warrants protection besides personal data, such as security data managed by entities. Security data can include data relating to national security, infrastructure security, and other privacy and security-related issues. In alternative embodiments utilized to assess the applicability and risks of data processes for security data, the focus may be on risks to the security data managed by these entities for infrastructure entities and government agencies, rather than on risks to the rights to personal data of individuals.

With reference to FIG. 3A, dynamically adaptable risk assessment and communication system 300 includes multiple interacting modules 320, 340, 360 and 380. These interacting modules include a rules management module 320, an entity profile management module 340, a data process modeling management module 360 and a risk assessment management module 380. At the center of these modules, for the present embodiment, are a set of applicability and risk assessment engines 305, 310, 311 and 313 which automatically apply a dynamic set of applicability and risk assessment rules 301 against a developing and dynamic knowledge base 303 and a data process model 307 (generated by data process modeling engine 306) to provide a set of risk assessment outputs 312. A task manager 314 may be utilized to assist in generating and managing various tasks needed for updating knowledge base 303, generating data process model 307, and for obtaining additional information needed for performing applicability determinations and risk assessments such as described herein. In addition, each module references a user 302, 304, 308 and 315 interacting with the elements of that module. However, a single user may interact with the elements of multiple modules. In addition, more than one user may interact with the elements of a single module.

With reference to FIG. 3B, rules management module 320 includes a set of applicability and risk assessment rules 301 that are managed by user 1 302 through user 1 GUI 330. These rules may be particular for a certain law, regulation, standard or other rules. These rules may also be specific for a given entity or across multiple entities. These rules may be generated by a specific entity or they may be generated by a third party managing such rules across and for multiple entities. These rules may be a set of if then else statements that apply conditions to a set of data describing an entity or entities to determine applicability of certain laws, regulations, standards and rules or to perform a risk assessment of data-related risks to individuals in accordance with the requirements of those laws, regulations, standards or rules. This set of data can include an entity profile such as general entity data, data regarding process flows utilized by the entity, preset data regarding risk assessment analysis, and other relevant information such as described herein. These laws, regulations, standards or rules which have been analyzed and documented as a set of rules in rules 301 are referred to herein as coded standards. That is, coded standards refer to laws, regulations, standards or rules which may be implemented as a set of rules to determine applicability and perform risk analysis of those laws, regulations, standards and rules for a selected entity or entities. Rules 301 include entity profile based applicability rules 322, entity process based applicability rules 324, risk assessment identification rules 326 and risk assessment examination rules 328. These rules are utilized by entity profile applicability engine 305, entity process applicability engine 310, risk assessment identification engine 311 and risk assessment examination engine 313, collectively referred to as risk engine 390.

In the present embodiment, entity profile based applicability rules 322 are rules utilized by entity profile applicability engine 305 against knowledge base 303 to determine the possible applicability of one or more coded standards to an entity based on that entity's general profile. For example, if an entity does business in the State of California and derives revenue from selling consumer's personal information, then the CCPA (California Consumer Privacy Act) may apply to that entity. Further analysis of that entity's data processes may be needed to make a final determination of applicability. If a determination of possible applicability is made based on these entity profile based applicability rules, then in this example a user may model the data processes with a California nexus to make a final determination of CCPA applicability. A similar determination of applicability can be made based on an entity's profile with other coded standards resulting in possibly modeling that entity's data processes which have a nexus to the applicable law, regulation or rules. For purposes of the present invention, an entity is an organization created to carry on a trade, business or other operational purpose and may be a company, a partnership, a non-profit organization, a standards body, a governmental agency or other governmental unit, etc. In the present embodiment, entity process based applicability rules 324 are utilized by entity process applicability engine 310 to determine the possible applicability of a one or more coded standards to an entity based on that entity's data processes. For example, if an entity stores and utilizes data about EU-based employees or customers, then the GDPR (General Data Protection Regulation) may apply to that entity, possibly necessitating a risk assessment of that entity's processes. A similar determination of applicability can be made based on an entity's processes with other coded standards resulting in possibly performing a risk analysis of that entity's data processes which have a nexus to the applicable law, regulation or rules.

In the present embodiment, risk assessment identification rules 326 are rules utilized by risk assessment identification engine 311 with data process model 307 to identify whether there may be a sufficiently high risk of possible risk of an adverse impact to individuals as a result of the data processing such that further examination of that entity's data processes and controls is needed to ascertain whether that risk can be sufficiently mitigated in accordance with applicable laws, regulations or rules. For example, if a large amount of EU customer data is processed, then there may be a high risk to the rights of individuals in accordance with the GDPR such that further examination may be performed on the relevant data processes and controls for that entity. This risk assessment is performed utilizing the entity profile and a model of the entity's data processes including data flows and survey results. Also in the present embodiment, risk assessment examination rules 328 are rules utilized by risk assessment examination engine 313 with data model 307 and additional input by user 1 to examine the entity's data processes and controls to examine further the data processing risk to individuals. This further examination can include mitigation of the risks such as through the use of process controls and other risk mitigation techniques as well as acceptance of all or a portion of the risks as a result of a risk-benefit analysis, confirmation of insurance coverage, protections through contract (e.g., indemnifications by third parties), etc.

With reference to FIG. 3C, entity profile management module 340 may include a knowledge base 303 with a variety of information about a given entity. This entity information can include an entity profile 342 and one or more simulation profiles 352 that are managed by user 2 304 through user 2 GUI 358. Entity profile 342 includes a variety of information regarding the entity that may be useful for determining applicability of certain rules, regulations and rules as well as be useful for performing a related risk assessment. Other information may also be included in entity profile 342 for other purposes as well such as for maintaining an audit trail of the processes described herein. Simulation profile is a simulated entity profile which can be utilized for performing certain “what if” scenarios. For example, an entity may be considering expanding operations to another country and that entity may want to identify the impact of that expansion on various coded standards for the laws, regulations, standards and rules that country we well as other countries. Entity profile 342 includes entity data 343, a data process model 344, applicability data 345, risk assessments 346 and audit trail 347. Simulation profile 352 includes entity data 353, data process model 354, applicability data 355, risk assessments 356 and audit trail 357. Entity data 343 and 353 include a variety of information regarding the entity including the entity's locations, number of employees by location or country, sales and/or revenue by location or country, number of customers by location or country, etc. This entity data includes information that may be useful for determining the possible applicability of a set of rules to an entity based on that entity's profile. This entity data may be obtained from user 2 through a set of queries or a survey provided to user 2 through GUI 358. Data process models 344 and 354 include a variety of process flows of personal and other data through the entity. This can include specific data process flows with nodes and edges as described below as well as survey data provided by user 2 or obtained from the entity profile. Data process models 344 and 354 may be stored as modified versions of data process model 307 described herein. Applicability data 345 and 355 may include the results of entity profile applicability engine 305 and entity process applicability engine 310 and may include other information such as user modification of the results of those engines as well as related comments by that user. Risk assessment data 346 and 356 may include the results of risk assessment identification engine 311 and risk assessment examination engine 313 and may include other information such as user modification of the results of those engines as well as related comments by that user. Audit trail 347 and 357 include a historical record of the operations of the dynamically adaptable risk assessment and communication system as well as actions of the users and their comments. This audit trail is useful for a variety of reasons including communicating the results of all the processes described herein to an auditor or for future users of this system. Additional or alternative information may also be stored in knowledge base 303, entity profile 342 and simulation profile 352.

With reference to FIG. 3D, data process modeling management module 360 includes entity profile applicability engine 305, data process modeling engine 306 and data process model 307 which are managed by user 3 308 through user 3 GUI 366. Entity profile applicability engine 305 may utilize entity profile based applicability rule in rules database 301 applied against an entity profile in knowledge base 303 to determine the possible applicability of certain coded standards to the entity. Based on this determination, user 3 through user 3 GUI 366 may utilize data process modeling engine 306 to generate or update selected data process models 307 describing various aspects of the entity and its data process flows. This can include the results of a survey 362 and some data process maps 364. The generation and use of data process maps 364 are described in greater detail below. Generally, the data process flows selected for mapping are those data process flows with a nexus to the coded standards deemed applicable by entity profile applicability engine 305. Once data process model 307 has been generated or updated, it may be utilized by entity process applicability engine 310 with rules 301 to determine whether certain coded standards are applicable to the data process flows on the entity. Then risk identification assessment engine 311 identifies whether the data process flows as mapped in data process model 307 are at high risk for being non-compliant with the applicable coded standards. If so, then risk examination engine 313 performs a further examination of those data process flows and relevant process controls to determine whether the associated risks are mitigated or justified.

With reference to FIG. 3E, risk assessment examination engine 313 includes entity process applicability engine 310, risk assessment identification engine 311, risk assessment outputs 312, risk assessment examination engine 313 and task manager, all of which may be managed by user 4 315 through user 4 GUI 385. Entity profile applicability engine 305 may determine the possible applicability of certain coded standards by applying entity profile based applicability rules from rules 301 against entity profile in knowledge base 303, with the outputs stored as profile applicability 381 in risk assessment outputs 312. In addition, entity process applicability engine 310 may further determine the applicability of certain coded standards by applying entity process based applicability rules from rules 301 against data process model 307 and an entity profile in knowledge base 303, with the outputs stored as process applicability 382 in risk assessment outputs 312. Risk assessment identification engine 311 may then perform a risk analysis of data-related risks to individuals in accordance with the requirements of the applicable coded standards by applying risk assessment identification rules from rules database 301 against data process model 307 and knowledge base 303 as well as user 4 input through user 4 GUI 385, with the outputs stored as identification outputs 383 in risk assessment outputs 312. Those coded standards identified as high risk may then be examined further for mitigation of that high risk by risk assessment examination engine 313 applying rules 301 against data process model 307, knowledge base 303 as well as user 4 input though user 4 GUI 385, with the outputs stored as examination outputs 384 in risk assessment outputs 312. Profile applicability outputs from entity profile based applicability engine 322 may also be stored in risk assessments outputs 312. The assignments of various tasks to accomplish the various actions described herein may be managed by task manager 314, which is turn may be managed by user 4 through user 4 GUI 385.

FIGS. 4A-4E provide flow diagrams of the operation of the dynamically adaptable risk assessment and communication system modules, in which various embodiments of the present disclosure may be implemented. FIG. 4A provides a high-level flow diagram 400 of one or more users operating dynamically adaptable risk assessment and communication system 300 including multiple interacting modules 320, 340, 360 and 380 in which various embodiments of the present disclosure may be implemented. FIGS. 4B-4E provide more detailed flow diagrams 420, 440, 460 and 480 of one or more users operating each of the interacting modules 320, 340, 360 and 380 of the dynamically adaptable risk assessment and communication system 300. In addition, corresponding block diagrams for the overall system and for each of the multiple interacting modules are described above with reference to FIGS. 3A-3E. Operation of this system assists one or more users in determining whether certain coded standards may be applicable to a given entity and that entity's processes, providing an assessment of the risks involved in storing, using and sharing certain data and data types, and communication of that applicability determination and risk assessment. This communication facilitates collaboration among multiple users in a structured but adaptable way, to create a more efficient, computer-enabled means of assessing the applicability and risks of data processes involving a lifecycle of personal data including the lifecycle of certain data and data types.

With reference to FIG. 4A, a user generates or updates a set of rules in a first step 402. These rules may be particular for a certain law, regulation, standard or other rules. These rules may also be specific for a given entity or across multiple entities. These rules may be generated by a specific entity or they may be generated by a third party managing such rules across and for multiple entities. Then in a second step 404, a user documents an entity profile. This entity profile may be provided in response to a set of queries, may be extracted automatically from a set of databases or other data available on-line, or some combination thereof. Preferably the entity profile is in a common format suitable for applying a set of rules against the information contained therein.

Then in step 406, a set of entity profile based applicability rules are applied against selected information contained in the entity profile. These rules are utilized to determine the possible applicability of certain coded standards to the entity profiled. For example, if an entity is domiciled in South Africa and processes personal information that is entered into a record, then the South African Protection of Personal Information Act (POPIA or POPI Act) may apply to the entity. This determination of possible applicability is provided to a user for consideration in step 408. This determination may be provided to the user for consideration as a task to be performed. In step 408, the user then identifies and documents relevant data process flows in response to the determination in step 406. That is, the user utilizes the determination of possible applicability to identify data process flows that may have a relevant nexus to the determined law, regulation or rule. The user then generates one or more data process models describing the data flow such as described in greater detail below. In the POPIA example above, the user may identify and document any data process flows that involve the processing of personal data in South Africa.

Once the data process models have been generated, then in step 410, a set of entity process based applicability rules are applied to the data process models, possibly including information derived from the entity profile, to determine which coded standards are applicable to the entity. This will be a subset of the coded standards determined in step 406 above as more information regarding the entity is being utilized to make this determination. Then in step 412, a set of risk assessment identification rules are applied against the data process models to identify whether the entity may be at high risk for data-related risks to individuals in accordance with the requirements of coded standards determined in step 410. The user can then review these assessments and modify the results of those assessments based on that user's knowledge and experience. These adjustments are documented in an audit trail including any comments by the user in making those modifications. Based on these assessments and the user's modifications, in step 414 a determination is made as to whether additional examination is needed of possible data-related risks to individuals in accordance with the requirements of certain coded standards. If so, then in step 416, that examination is performed to determine whether there may be mitigating factors such as data process controls, whether there may be acceptance of the high risk based on a cost-benefit analysis, insurance coverage, etc. This step can include utilizing certain risk assessment examination rules.

FIG. 4B is a flow diagram directed to the operation of rules management module 320 to manage rules utilized to determine applicability and assess risk of certain coded standards to one or more entities in which various embodiments of the present disclosure may be implemented. In a first step 420, User 1 logs into rules management module 320 through GUI 330. This includes verifying the identity and access rights of user 1 to perform the following steps. User 1 may also be referred to herein as an administrative user. Although a single user GUI is shown in this module, multiple GUIs may be utilized for various aspects of rules module 320. In a second step 422, an incoming set of rules is received or accessed by User 1 through GUI 330 for future application to one or more entities. This may be a new rule or an update to a previous rule. This could be a new or updated rule for determining entity profile based applicability 322, entity process based applicability 324, risk assessment identification 326, risk assessment examination 328, or any other rule sets that may be developed or implemented with alternative embodiments of the present invention. User 1 then uses GUI 330 in step 424 to add or update the appropriate rule or rules in rules 301.

Subsequently, in step 426, user 1 may update knowledge base 303 including entity profile 342 as needed to include information needed to implement the new or updated rules from step 424. In addition, user 1 may also update any queries or other process steps described herein, including updating the various GUIs and task manager 314, to obtain the information needed to implement the new or updated rules for storage and use as described herein. Then in step 428, user 1 may also update the engines that implement these rules as needed, including entity profile applicability engine 305, entity process applicability engine 310, risk assessment identification engine 311 and risk assessment examination engine 313. Furthermore, in step 430 user 1 may also update risk assessment outputs 312 to communicate the various information needed to fully utilize the new or updated rules of step 424. Alternative embodiments may utilize other users to implement these various changes when a new or updated rule is provided for updating rules 301. In step 432, an audit trail is maintained or updated of the information provided in the steps above. This audit trail may be stored in knowledge base 303 as audit trail 347. This audit trail can include pointers to or copies of the rules added or modified as well as an identification of the user that provided the rules that were added or modified.

FIG. 4C is a flow diagram directed to the operation of entity profile management module 340 to generate, update and manage an entity or simulated profile in knowledge base 303 in which various embodiments of the present disclosure may be implemented. In a first step 440, User 2 logs into entity profile management module 340 through GUI 358. This includes verifying the identity and access rights of user 2 to perform the following steps. User 2 may also be referred to herein as an entity profile user. Although a single user GUI is shown in this module, multiple GUIs may be utilized for various aspects of entity profile management module 340. In a second step 442, user 2 selects which entity or simulation to provide or update information. This selection can include adding a new entity or simulation of an entity. An entity may be a single entity or multiple interrelated entities combined and treated as a single entity for purposes of describing the present embodiment. In the case of multiple interrelated entities, each entity may also be treated as a single entity as described below, then the result combined to determine the use cases that apply to the combined entity. Also, for multiple entities, data for and processing of the present embodiment may be maintained on separate virtual systems or as isolated copies with firewalls in-between for each entity or group of entities so as to preserve the confidentiality of data from other entities or groups of entities.

In a third step 444, user 2 provides or updates entity data 343 to entity profile 342 and/or simulation profile 352 selected in step 442. Entity data 343 and 353 include a variety of general information regarding the entity including organizational information regarding the entity. This can include the entity's locations, number of employees by location or country, sales and/or revenue by location or country, number of customers by location or country, etc. This entity data includes information that may be useful for determining the possible applicability of a set of rules to an entity based on that entity's profile. Other information may also be included for documentation or other purposes. This entity data may be obtained from user 2 through a set of queries or a survey provided to user 2 through GUI 358. In the case of a simulation entity, the user may simply duplicate an existing entity for simulation purposes and then modify that duplicate as needed for the simulation.

In step 446, user 2 may select an option through GUI 358 to modify certain results in the applicability data and the risk assessments. Generally such modifications may be made as described in FIGS. 4D and 4E below. User 2 may not generally be authorized to make such modifications from a control standpoint. However, such modifications may be authorized and made pursuant to a task assigned to user 2 task manager 314, perhaps at the request of user 4 such as described below with reference to FIG. 4E. An example of such modifications that user 2 may be authorized to perform, or which may be pursuant to a task from task manager 314, could be to generate or modify applicability data 355 and risk assessments 356 of simulation profile 352 to perform some “what if” scenarios. Generally, user 2 may not modify data process model 344 as the GUI tailored for such modifications would be GUI 366 in the data process modeling management module 360 as described below with reference to FIG. 3D. Subsequently, in step 448, an audit trail is maintained or updated of the information provided in any of the above described steps such as steps 444 and 446. This audit trail may be stored in knowledge base 303 as audit trail 347. This audit trail can include pointers to or copies of the data added or modified as well as an identification of the user that provided the data that was added or modified.

FIG. 4D is a flow diagram directed to the operation of data process modeling management module 360 to generate, update and manage data process model 307 in which various embodiments of the present disclosure may be implemented. In a first step 460, user 3 logs into data process modeling management module 360 through GUI 366. This includes verifying the identity and access rights of user 3 to perform the following steps. User 3 may also be referred to herein as a data process modeling user. Although a single user GUI is shown in this module, multiple GUIs may be utilized for various aspects of data process modeling management module 360. In a second step 462, user 3 selects an entity or multiple entities for processing as described below. In the case where user 3 selects multiple entities, they may be a group of related entities which user 3 wants evaluated together. This selection of entities and subsequent steps below may be a result of a task assigned to user 3 by task manager 314, perhaps at the request of user 4 such as described below with reference to FIG. 4E.

In step 464, user 3 may optionally invoke entity profile applicability engine 305 to identify which coded standards may possibly be applicable to the entity or entities selected by user 3 in step 462. Then in step 466, entity profile applicability engine 305 applies entity profile based applicability rules 322 against the entity profiles of selected entity or entities to identify for user 3 which coded standards may apply to the selected entities. For example, if the selected entities have employees or customers in the EU, then the GDPR may apply. This is not a final determination of applicability, but a preliminary possibility of applicability based on the entity profiles of the selected entities. Additional information such as data process flows of personal data is needed for performing a more detailed analysis such as described below. Subsequently in step 468, user 3 reviews the identified coded standards and selects which of those coded standards should receive further analysis. For example, even though the selected entities may do some business in the EU and the GDPR was identified as being potentially applicable, user 3 may determine that no further analysis is needed. This determination could be based on a variety of factors such as user 3's knowledge that no personal data is collected, stored or utilized from or in the EU by the selected entities that would make the entity subject to the GDPR. In addition, user 3 may select a coded standard which was not deemed to be applicable by entity profile applicability engine 305. The results of this entity profile applicability determination and subsequent user 3 selection may be stored in risk assessment outputs as profile applicability 381 and in knowledge base 303 as a portion of applicability data 345. Then in step 469, user 3 (or other users) selects data process flows of the selected entity or entities for documentation and for further analysis by risk assessment management module 380 as described below. This selection can be based on known personal data which may have a nexus to the country or other area which has potentially applicable laws, regulations, standards or rules which have been implemented as coded standards as described above with reference to FIG. 3B.

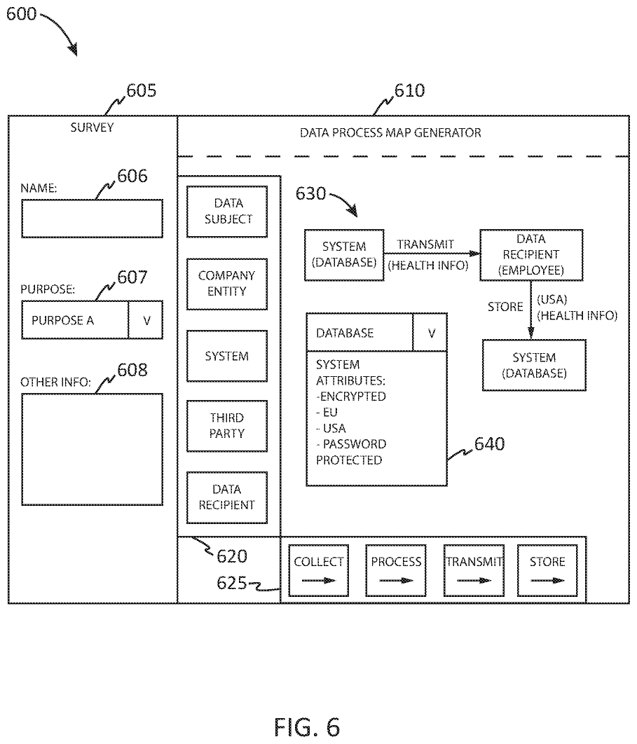

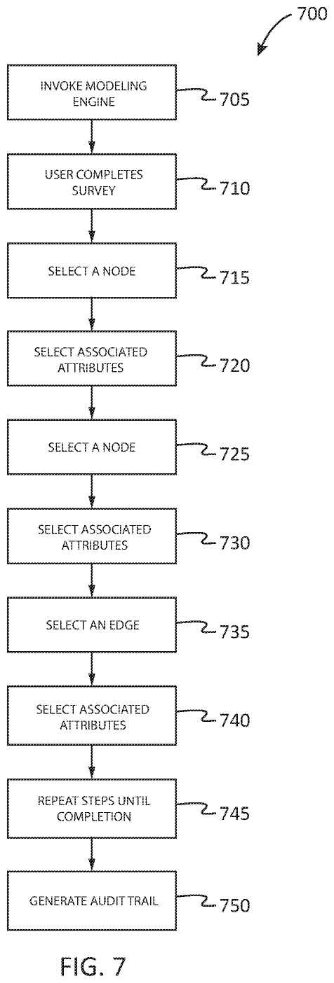

In step 470, user 3 invokes data process modeling engine 306 for documenting the selected data process flows as data process model 307 through GUI 366. For ease of description, the following documentation process will be described with reference to a single selected data process flow for a single entity. However, the process can be repeated for multiple data process flows or for multiple entities. In addition, this process may also be utilizing for modifying a previously documented data process flow. In step 472, user 3 may provide some general information regarding the selected data process flow. This may be in response to a survey or other form of question and answer process with user 3. This general information regarding the data process flow is stored as survey 362 (shown in FIG. 3D). Then in step 474, user 3 may document the selected data process flow as data process map 364 (shown in FIG. 3D). This may be accomplished through a combination of data item identification (particularly personal data items), data item origination location, data item storage location, data item usage, data item transfer, data item archival and removal, etc. through the use of nodes and edges in the data process map 364. This process is described below in greater detail in FIGS. 6 and 7. Once user 3 has completed the documentation of the selected data process item, then in step 476 the resulting survey and data process map is stored in knowledge base 303 as data process model 344.

Subsequently, in step 478, an audit trail is maintained or updated of the information provided in any of the above described steps such as steps 466 through 476. This audit trail may be stored in knowledge base 303 as audit trail 347. This audit trail can include pointers to or copies of the data added or modified as well as an identification of the user that provided the data that was added or modified.

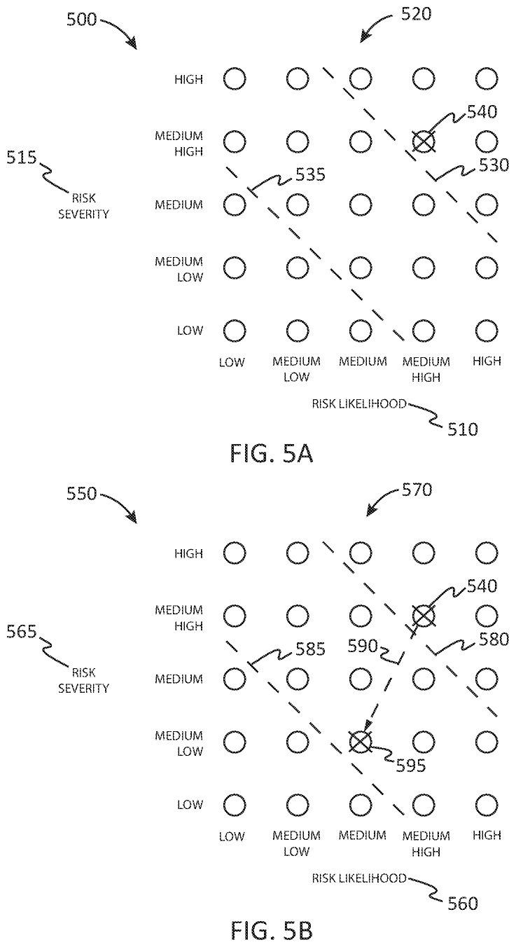

FIG. 4E is a flow diagram directed to the operation of risk assessment management module 380 for determining whether certain coded standards may be applicable to a given entity and that entity's processes, providing an assessment of the risks involved with that entity's processes, and communication of that applicability determination and risk assessment to other users in which various embodiments of the present disclosure may be implemented. FIGS. 5A and 5B are heat diagrams which may illustrate the results of the risk assessments generated herein. In a first step 480, user 4 logs into risk assessment management module 380 through GUI 385. This includes verifying the identity and access rights of user 4 to perform the following steps. User 4 may also be referred to herein as a risk assessment user or as a managing user. Although a single user GUI is shown in this module, multiple GUIs may be utilized for various aspects of risk assessment management module 380. In a second step 481, user 4 selects an entity or multiple entities for processing as described below. In the case where user 4 selects multiple entities, they may be a group of related entities which user 4 wants evaluated together. This selection of entities and subsequent steps below may be a result of a prior task assigned to user 4 by task manager 314.

In step 482, user 4 may optionally invoke entity process applicability engine 310 to identify which coded standards may possibly be applicable to the entity or entities selected by user 4 in step 482. Then in step 483, entity process applicability engine 310 applies entity process based applicability rules 324 against data process model 307 to identify for user 3 which coded standards may apply to the selected entities. For example, if the selected entity does business in the State of California but has annual revenues less than a preset threshold, receives personal information from less than a preset threshold of consumers, households or devices and does not derive 50% or more of its annual revenue from selling consumer's personal information, then the CPAA may not apply. This is not a final determination of applicability, but a strong indication of applicability based on the process flows of the selected entities. Subsequently in step 484, user 4 reviews the identified coded standards and selects which of those coded standards should receive risk analysis as described below. For example, even though the selected entities may do limited business in Canada and the entity's process flows may show low data risks to individuals, user 4 may determine that some risk analysis is needed. This determination could be based on a variety of factors such as user 4's knowledge that the entity derives a significant percentage but less than 50% of its annual revenues from selling consumer's personal information. In addition, user 4 may deselect or not select a coded standard which was deemed to be applicable by entity process applicability engine 310. The results of this entity process applicability determination and subsequent user 4 selection may be stored in risk assessment outputs as process applicability 382 and in knowledge base 303 as part of applicability data 345.

Then in step 485, user 4 may invoke risk assessment identification engine 311 which applies risk assessment identification rules 326 against data process model 307 as well as entity data 343 if needed for the selected coded standards and the selected entities. This risk assessment identifies whether the selected entities may be at risk for data-related risks to individuals in accordance with the requirements of the selected coded standards. This risk assessment may be described as low, medium low, medium, medium high or high severity level of risk. Other measures or risk levels may also be utilized and may depend on the underlying law, regulation, standard or rule that applies for the selected coded standard. This identified severity level of risk is then provided to user 4 in step 486. Subsequently in step 487, user 4 reviews the identified severity level of risk and can modify that assessment based on user 4's knowledge and experience and/or other sources of information. Then in step 488, user 4 provides a likelihood level of risk based on user 4's knowledge and experience and/or other sources of information. In step 489, both the severity level of risk and the likelihood level of risk are shown on a heat map as shown in FIG. 5A with severity on the y axis and likelihood on the x axis. This combination of severity level of risk and the likelihood level of risk provides an overall assessment of risk that the selected entities may have data-related risks under the selected coded standard. Alternative embodiments may utilize other forms of illustrating the severity level of risk and likelihood level of risk to user 4. Additional information may also be shown such as any particular rules that assessed a higher risk as well as any data items that caused the rule to assess a higher risk. Furthermore, space may be provided for user 4 to make any relevant comments. This combination of severity level of risk and likelihood of risk as well as any other relevant information and comments by user 4 may be stored in risk assessment outputs 312 as identification 383. As shown in FIG. 5A, several combinations of high risk and medium high risk may result in an overall high risk assessment that may necessitate further examination of the selected entity's process controls and other factors.

In step 490, user 4 determines whether to proceed with a further risk assessment examination. In the case of the GDPR, this may take the form of a DPIA (Data Protection Impact Assessment). This may also be based on the requirements of other types of coded standards or this may be an internally based risk assessment examination to better understand the risks involved with a given coded standard. In either case, if user 4 determines to proceed with a further risk assessment examination, then in step 491 user 4 invokes risk assessment examination engine 313. In step 492, risk assessment examination engine 313 applies risk assessment examination rules 328. These rules may be more than if then else statements and may include a combination of queries and surveys of information needed regarding a variety of factors. These factors may be specific for a given coded standard or may be generic across two or more coded standards or even all standards. For example, there may be queries and/or surveys regarding process controls which may mitigate certain risks, risk-benefit analyses to assess the value of the use of certain data against the risks involved with utilizing that data, confirmation of certain types of insurance coverage and protections through contract (e.g., indemnifications by third parties) relevant to the data at risk, and other factors which may mitigate or affect the acceptance of certain risks. Then in step 493, user 4 interacts with these queries and information surveys to provide information as needed to obtain a set of risk assessment examination results. In step 494, user 4 then reassesses the severity and likelihood levels of risk based on this further examination of the risks and based on user 4's knowledge and experience and/or other sources of information. In step 495, both the severity level of risk and the likelihood level of risk and any adjustments to those levels of risk are shown on an updated heat map as shown in FIG. 5B with the risk severity level on the y axis and the risk likelihood level on the x axis. As shown in FIG. 5B, the adjustments to the levels of risk may reduce an overall high risk assessment to an overall medium risk assessment. If the overall risk assessment is still high, then additional steps may be taken such as modifying the types or volume of data collected, utilized and stored, which could be reflected in updated entity data process maps. After such changes, many of the above steps may be repeated with the new information to obtain an updated risk assessment.

Then in step 496, user 4 may invoke task manager 314 to assign certain tasks to be performed by other users (or even be self-assigned by user 4). These tasks can include any of the steps described above, requested modifications to the collection, use, storage, archival or transfer of data (e.g., encrypting certain data for security purposes), rerunning of any of the steps above including the applicability of coded standards and risk assessments, etc. This use of task manager 314 by user 4 may occur at any step of the above described processes, or may be utilized by other authorized users at any appropriate time. User 4 may be able to approve, add or remove certain tasks as well as assign and prioritize these tasks. Subsequently, in step 497, an audit trail is maintained or updated of the information provided in any of the above described steps. This audit trail may be stored in knowledge base 303 as audit trail 347. This audit trail can include pointers to or copies of the data added or modified as well as an identification of the user that provided the data that was added or modified.

FIGS. 5A-5B provide heat maps illustrating the results of risk assessments in which various embodiments of the present disclosure may be implemented. Alternative embodiments may utilize alternative ways to illustrate the relative levels of risk. FIG. 5A is a heat map 500 such as may be generated in step 489 above. This heat map includes a risk likelihood 510 on the x axis and risk severity 515 on they axis, each axis having five levels of risk from low to high. The intersections of these risk levels are shown as radio buttons 520. These radio buttons are segregated or otherwise gradated by lines 530 and 535 as being either overall high risk (to the right of line 530), medium risk (between lines 530 and 535), and low risk (to the left of line 535). When the risk assessment identification engine identifies a severity level of risk, a corresponding row of radio buttons may be highlighted. The user can then select a combination of severity level of risk and likelihood level of risk by clicking on a radio button such as radio button 540. This radio button may be on the highlighted row of radio buttons or a different row as described above. Based on the location of selected radio button 540, the overall level of risk may be high, medium or low. In the present example it is high, so a further examination of the risk may be performed.

FIG. 5B is a heat map 550 such as may be generated in step 495 above. This heat map includes a risk likelihood 560 on the x axis and risk severity 565 on the y axis, each axis having five levels of risk from low to high. The intersections of these risk levels are shown as radio buttons 570. These radio buttons are segregated or otherwise gradated by lines 580 and 585 as being either overall high risk (to the right of line 580), medium risk (between lines 580 and 585), and low risk (to the left of line 585). When the risk assessment examination engine has completed a requested examination of risk, the user is given an option to modify the severity level of risk and the likelihood level of risk by selecting a new radio button such as radio button 595. This radio button may be different than radio button 540 such as selected above. As a result, based on the location of selected radio button 595, the overall level of risk may remain the same or be modified from high to medium or low risk. In the present example, both radio button 540 selected in FIG. 5A and the radio button selected in FIG. 5B are shown with an arrow 590 showing the direction of modification. While the present example shows the modified risk for a single coded standard, an alternative example could show the modified risk for multiple coded standards, perhaps with each coded standard indicated with a different color.

FIG. 6 provides a GUI (graphical user interface) for generating a data process model 600 in which various embodiments of the present disclosure may be implemented. A data process model can include the results of a survey 605 and a data process map generator 610 where nodes (shown as blocks) graphically represent data objects and edges (shown as arrows) graphically represent data paths that are the connections or pathways between the various nodes. Nodes can represent various types of data objects such as data subjects, company entities, systems, third parties (e.g., vendors and/or partners), data recipients, etc. Edges can represent various types of data flows such as sending and receiving data between nodes as well as operations on data. In an alternative embodiment, operations on data may be represented by nodes instead of edges.

In this embodiment, each data object may have associated attributes such as location (e.g., country, state or other legal jurisdictions), type of entity, type of system (e.g., database, website), data subject (e.g., employee), data type (e.g., financial, health, location and other personal information), data elements (e.g., social security number), etc. Each data flow may have associated attributes such as the type of action (e.g., collect, process, transmit or store information related to a node), data types (e.g., health information, financial information, etc.), data elements (e.g., social security number, customer address), data volume, etc. In combination, nodes and edges are interconnected to represent data flowing between data objects. For example, edges can connect an organization node to a system node that organization uses to collect, process, transmit and/or store personal information relating to a set of data subjects to a set of data recipients to whom personal information about the set of data subjects is disclosed or transferred (e.g., health information to insurance companies). Edges can also connect data subjects, organizations, data recipients and/or vendors represented by nodes with specific countries/jurisdictions. For example, an organization represented by a node may collect personal information from data subjects represented with an edge whereby the data subjects have a location attribute of France in the European Union. As a result, the GDPR may apply because personal information from France is being collected by the organization.

This type of data process modeling enables the profile applicability engine and the risk assessment engines to apply rules to the survey 605 (which may also be survey 362 of FIG. 3D) as well as the data process map 610 (which may also be data process map 364 of FIG. 3D). For another example, a customer would be able to search for and filter all business processes involving the transfer of financial information about an EU data subject to the UK. In this example, this application of a rule is possible because the nodes are associated with locations and the edges are associated with attributes about what data is used, the location where the data is coming from, and the purpose for which that data is being used in this mapped data process

In FIG. 6, survey 605 requests information regarding the data process being modeled. This includes a name 606 and purpose 607 of the data process. The name may be entered by the user, but the purpose may be from a limited selection of choices for applying rules to the resulting data process map. Other information 608 may be gathered regarding the data process as needed for rule application.

Data process map generator 610 can include a set of nodes 620 graphically representing data objects as well as a set edges 625 graphically representing data paths. These nodes and edges may be selected and dragged and dropped onto a data process map 630. As each mode and edge is selected, dragged and dropped, a pop up box 640 may appear so the user can select the appropriate attributes for the data object or data path represented by the respective node or edge. Through this process, the user can generate a complete data process map representing a data process. In the present example, there are five data objects 620 to choose from including data subjects, company entities, systems, third parties and data recipients. Also in the present example, there are four types of data flows 625 to choose from including collecting, processing, transmitting, and storing data. The data objects and data flows and the associated attributes provided for building the data process map are derived from the underlying coded standards and the rules utilized to determine the applicability and risk assessment of those coded standards. That is, if a coded standard identifies a certain attribute as being necessary to determine applicability or risk assessment of a code standard, then the list of attributes may be updated with that attribute as a choice in pop up box 640. In the present simplified example, a database is transmitting health information to an employee for storage in a second database. Pop up box 640 includes a reference to the second system database and shows some of the attributes that may be selected.

Any node or edge with its attributes, or a subset of its attributes, may be stored as data objects or data flows for use in another data process model. That is, a node representing a database may be utilized in multiple data process models representing multiple data processes. This helps prevent duplication of effort by users in documenting multiple process controls utilizing a common database or other element being represented by a node or edge. In addition, if a modification is made to a data object stored in one data process map, that modification may automatically be applied to all data process maps utilizing that data object unless a user blocks such modifications for a given data process model. For example, additional personal data may be stored in a database accessible by users, necessitating the need to update the attributes of all nodes representing that database.

FIG. 7 provides a flow diagram 700 illustrating how a data process model is generated in which various embodiments of the present disclosure may be implemented. In a first step 705, the user invokes a data process modeling engine to provide a GUI for the user to generate a data process model. The in step 710, the user completes a survey of general information regarding the data flow being modeled. In step 715, the user selects a node representing a data object and drags and drops that node onto a location on a data process map. The user then selects attributes for that selected node from a pop up box or other user interface in step 720. Then in step 725, the user selects another node representing a data object and drags and drops that node onto another location of the data process map. In step 730, the user then selects attributes for that selected node from a pop up box or other user interface. Then in step 735, the user selects an edge representing a data flow and drags and drops that selected edge linking the two previously selected nodes. In step 740, the user then selects attributes for that selected edge from a pop up box or other user interface. In step 745, the user repeats the above steps of selecting nodes and edges and associated attributes until the data process model is completed. Subsequently, in step 750, an audit trail is maintained or updated of the information provided in any of the above described steps. This audit trail may be stored in a knowledge base and/or in an audit trail database. This audit trail can include pointers to or copies of the data added or modified as well as an identification of the user that provided the data that was added or modified.

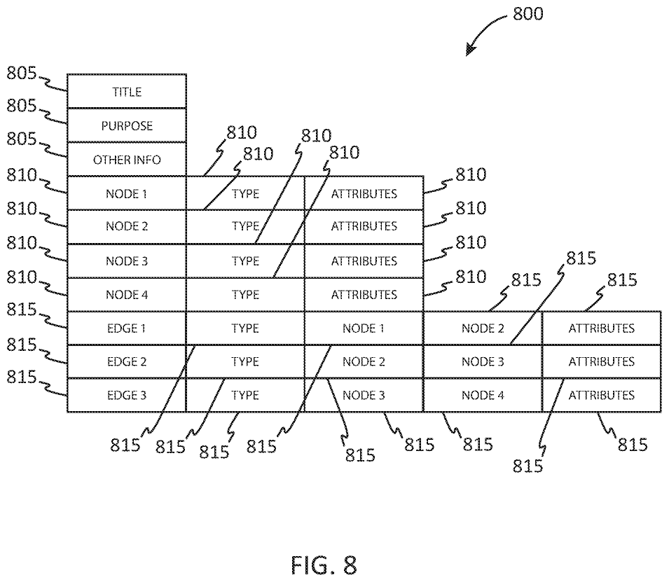

FIG. 8 provides a block diagram of a set of records for a data process map 800 in which various embodiments of the present disclosure may be implemented. A record is a set of information within a domain or database that establishes a relationship between a set of data or data elements. A record may be a separate entry into a database, a set of links between data, or other logical relationship between a set of data. Data process map 800 includes three main components for representing a data process flow that can be analyzed by a set of rules to determine the applicability and to perform a risk assessment of one or more coded standards. The components are survey results 805, nodes or data objects 810 and edges or data flows 814. In combination, nodes and edges are interconnected to represent data flowing between data objects and survey results provide general information regarding that flow of data.

Survey results 805 include general information regarding the data process map including a title, purpose and other information. The title may be used mainly for identifying and labeling the data process map. However, the purpose and other information may be utilized by a set of rules to determine the applicability and provide a risk assessment of one or more coded standards.

Nodes 810 can represent various types of data objects such as data subjects, company entities, systems, third parties (e.g., vendors and/or partners), data recipients, etc. Nodes 810 include a node identifier, a node type and a set of node attributes. The node identifier may be used mainly for identifying and labeling the data object represented by the node as well as a use by edges as described below to identify which nodes are interconnected by those edges. The node type is the type of data object being represented such as data subject, company entity, etc. Each node can include various types of attributes associate with that node including location (e.g., country, state or other legal jurisdictions), type of entity, type of system (e.g., database, website), data subject (e.g., employee), data type (e.g., financial, health, location and other personal information), data elements (e.g., social security number), etc. These node types and attributes are useful for applying a set of rules to determine the applicability and to perform a risk assessment of one or more coded standards.

Edges 815 can represent various types of data flows such as sending and receiving data between nodes as well as operations on data. Edges interconnect the various nodes. Edges 815 include an edge identifier, an edge type, generally two node identifiers, and a set of edge attributes. The edge identifier may be used mainly for identifying and labeling the data flow represented by the edge. The edge type is the type of data flow such as sending and receiving data between nodes as well as operations on data. Two or more nodes may be identified to indicate an interconnection between those nodes by an edge, indicating a data flow between data objects. In addition, each edge can include various types of attributes associated with that edge including a type of action (e.g., collect, process, transmit or store information related to a node), data types (e.g., health information, financial information, etc.), data elements (e.g., social security number, customer address), data volume, etc. These edge types, node interconnections, and attributes are useful for applying a set of rules to determine the applicability and to perform a risk assessment of one or more coded standards. The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for a risk assessment of processes involving personal data, including sensitive data. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of performing a risk assessment, to a coded standard, of data-related risk within a data process comprising:
obtaining a model of the data process, the model including an identified purpose of the data process and identified nodes representing data objects interconnected with identified edges representing data flows; and
applying a set of rules associated with the coded standard against the modeled data process to provide a risk assessment to the coded standard of a severity level of risk generated by the data process to the coded standard.

2. The method of claim 1 further comprising:
obtaining a profile of the entity including location and type of entity;
applying a second set of rules associated with the coded standard against the profile of an entity to determine whether the coded standard applies to that entity.

3. The method of claim 1 wherein the coded standard is directed to protecting personal data of individuals and the risk assessment is directed to assessing data-related risk to the personal data of those individuals.

4. The method of claim 3 wherein the personal data is sensitive personal data.

5. The method of claim 1 wherein the coded standard is directed to protecting security data managed by entities and the risk assessment is directed to assessing data-related risk to the security data managed by those entities within the data process.

6. The method of claim 1 further comprising:
receiving a likelihood level of risk corresponding to the severity level of risk; and
combining the severity level of risk with the likelihood level of risk to provide an overall risk assessment.

7. The method of claim 6 further comprising:
responsive to the overall risk assessment being at a high level, generating a set of tasks to be performed for reducing the overall risk assessment;
responsive to completion of the set of tasks, obtaining an updated model of the data process upon completion of the set of tasks; and
applying the set of a set of rules associated with the coded standard against the updated model to provide an updated risk assessment of the severity and likelihood level of risk.

8. The method of claim 1 wherein the set of rules associated with the coded standard represent standards from multiple jurisdictions potentially applicable to an entity for protecting personal data.

9. A computer program product for performing a risk assessment, to a coded standard, of data-related risk within a data process, the computer program product comprising a non-transitory computer readable storage medium having program instructions embodied therewith, the program instructions processed by a processing circuit to cause the device to perform a method comprising:
obtaining a model of the data process, the model including an identified purpose of the data process and identified nodes representing data objects interconnected with identified edges representing data flows; and
applying a set of rules associated with the coded standard against the modeled data process to provide a risk assessment to the coded standard of a severity level of risk generated by the data process to the coded standard.

10. The computer program product of claim 9 further comprising:
obtaining a profile of the entity including location and type of entity;
applying a second set of rules associated with the coded standard against the profile of an entity to determine whether the coded standard applies to that entity.

11. The computer program product of claim 9 wherein the coded standard is directed to protecting personal data of individuals and the risk assessment is directed to assessing data-related risk to the personal data of those individuals.

12. The computer program product of claim 11 wherein the personal data is sensitive personal data.

13. The computer program product of claim 9 further comprising:
receiving a likelihood level of risk corresponding to the severity level of risk; and
combining the severity level of risk with the likelihood level of risk to provide an overall risk assessment.

14. The computer program product of claim 13 further comprising:
responsive to the overall risk assessment being at a high level, generating a set of tasks to be performed for reducing the overall risk assessment;
responsive to completion of the set of tasks, obtaining an updated model of the data process upon completion of the set of tasks; and
applying the set of a set of rules associated with the coded standard against the updated model to provide an updated risk assessment of the severity and likelihood level of risk.

15. A data processing system for performing a risk assessment, to a coded standard, of data-related risk within a data process, the data processing system comprising:
a processor; and
a memory storing program instructions which when processed by the processor perform the steps of:
obtaining a model of the data process, the model including an identified purpose of the data process and identified nodes representing data objects interconnected with identified edges representing data flows; and
applying a set of rules associated with the coded standard against the modeled data process to provide a risk assessment to the coded standard of a severity level of risk generated by the data process to the coded standard.

16. The data processing system of claim 15 further comprising:
obtaining a profile of the entity including location and type of entity;
applying a second set of rules associated with the coded standard against the profile of an entity to determine whether the coded standard applies to that entity.

17. The data processing system of claim 15 wherein the coded standard is directed to protecting personal data of individuals and the risk assessment is directed to assessing data-related risk to the personal data of those individuals.

18. The data processing system of claim 17 wherein the personal data is sensitive personal data.

19. The data processing system of claim 15 further comprising:
receiving a likelihood level of risk corresponding to the severity level of risk; and
combining the severity level of risk with the likelihood level of risk to provide an overall risk assessment.

20. The data processing system of claim 19 further comprising:
responsive to the overall risk assessment being at a high level, generating a set of tasks to be performed for reducing the overall risk assessment;
responsive to completion of the set of tasks, obtaining an updated model of the data process upon completion of the set of tasks; and
applying the set of a set of rules associated with the coded standard against the updated model to provide an updated risk assessment of the severity and likelihood level of risk.
